(19) United States
(12) Patent Application Publication
(10) Pub. No.: US 2007/0005150 A1
(43) Pub. Date: Jan. 4, 2007

(54) Remote testing system and method

(75) Inventor: Jason Lai, Shindian City (TW)

Correspondence Address: BIRCH STEWART KOLASCH & BIRCH, PO BOX 747, FALLS CHURCH, VA, 22040-0747, US

(73) Assignee: VIA TECHNOLOGIES, INC.

(21) Appl. No.: 11/262,908

(22) Filed: Nov. 1, 2005

(30) Foreign Application Priority Data
Jun. 16, 2005 (TW) 094120081

(51) Int. Cl. G05B 15/00

(52) U.S. Cl. 700/1

(57) ABSTRACT

A remote testing system and method comprises at least one test operating terminal and a to-be-tested terminal. The test operating terminal outputs an operating command. The to-be-tested terminal comprises a serving module and a testing module. The serving module transmits at least one system parameter of the to-be-tested terminal to the test operating terminal, and receives the operating command then generates a testing command according to the operating command. The testing module executes a testing action to generate a testing result according to the testing command.

### BACKGROUND OF THE INVENTION

1. Field of Invention

The invention relates to a testing system and a testing method and, in particular, to a remote testing system and a remote testing method.

2. Related Art

In general, a hardware device is composed of several components. If the hardware device wants to execute normally, the components have to be coordinated using a suitable interface such as a driver.

As shown in FIG. 1, when a testing system 11 is testing an electronic device 12, the on-site developer has to operate the testing system 11 in order to observe the predefined value (e.g., the driver) of the electronic device 12, or the value of the register of each processing unit in the electronic device 12.

However, if the developer cannot arrive at the production line of the electronic device, the developer cannot successfully and conveniently test the electronic device 12. For example, if the electronic device 12 is a motherboard, and the system chip designer and manufacturer of the motherboard may be located at two places, the system chip designer cannot easily help the manufacturer to test the problems of the motherboard associated with the system chip.

Thus, it is an important subject of the invention to provide a remote testing system and a remote testing method of enabling the remote developer to test the electronic device without going to the electronic device developing place, so as to overcome the distance barrier between the developer and the electronic device developing place and enhance the efficiency of developing the electronic device.

### SUMMARY OF THE INVENTION

In view of the foregoing, the invention is to provide a remote testing system and a remote testing method capable of testing an electronic device remotely.

To achieve the above, a remote testing system of the invention includes at least one test operating terminal and a to-be-tested terminal. The test operating terminal outputs an operating command. The to-be-tested terminal includes a servo module and a testing module. The servo module transmits at least one system parameter of the to-be-tested terminal to the test operating terminal, receives the operating command, and generates a testing command according to the operating command. The testing module executes a testing action to generate a testing result according to the testing command.

In addition, the invention also provides a remote testing system including a first test operating terminal, a second test operating terminal and a to-be-tested terminal. One of the first test operating terminal and the second test operating terminal outputs an operating command. The to-be-tested terminal includes a servo module and a testing module. The servo module transmits at least one system parameter of the to-be-tested terminal to the first test operating terminal and the second test operating terminal, receives the operating command, and generates a testing command according to the operating command. The testing module executes a testing action to generate a testing result according to the testing command.

Furthermore, the invention also provides a remote testing method, which includes the steps of: transmitting at least one system parameter of a to-be-tested terminal to a first test operating terminal and a second test operating terminal; receiving an operating command outputted from one of the first and second test operating terminals; generating a testing command according to the operating command; and executing a testing action to generate a testing result according to the testing command.

As mentioned hereinabove, since the remote testing system of the invention have the servo module and the testing module, the system parameter of the to-be-tested terminal can be transmitted to a remote test operating terminal. Thus, the remote developer can perform the testing action of testing the electronic device without going to the on-site electronic device developing place so as to overcome the distance barrier between the developer and the on-site electronic device developing place and enhance the efficiency of developing the electronic device. In addition, the system parameter of the to-be-tested terminal may be synchronously transmitted to a plurality of remote test operating terminals. Accordingly, the remote developers can synchronously test the to-be-tested terminal, and the efficiency of testing the electronic device can be enhanced.

### BRIEF DESCRIPTION OF THE DRAWINGS

The invention will become more fully understood from the detailed description given herein below illustration only, and thus is not limitative of the present invention, and wherein:

FIG. 1 is a block diagram showing a conventional testing system;

FIG. 2 is a block diagram showing a remote testing system according to a preferred embodiment of the invention;

FIG. 3 is a block diagram showing a detailed implementation of the remote testing system according to the preferred embodiment of the invention;

FIG. 4 is a schematic illustration showing a display module for displaying system information in the remote testing system according to the preferred embodiment of the invention;

FIG. 5 is a schematic illustration showing the display module for displaying a testing result in the remote testing system according to the preferred embodiment of the invention;

FIG. 6 is a flow chart showing a remote testing method according to a preferred embodiment of the invention; and

FIG. 7 is a flow chart showing the detailed steps of the remote testing method according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

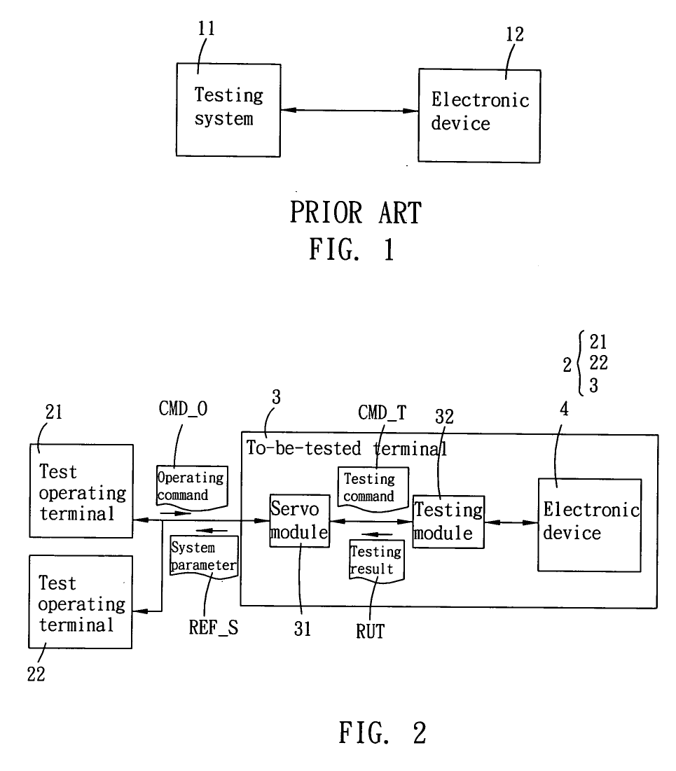

Referring to FIG. 2, a remote testing system 2 according to the preferred embodiment of the invention includes a test operating terminal 21 and a to-be-tested terminal 3. The to-be-tested terminal 3 includes a servo module 31, a testing module 32 and an electronic device 4.

The servo module 31 transmits a system parameter REF_S of the to-be-tested terminal 3 to the test operating terminal 21. The test operating terminal 21 outputs an operating command CMD_O, and the servo module 31 receives the operating command CMD_O and generates a testing command CMD_T according to the operating command CMD_O. The testing module 32 executes a testing action on the electronic device 4 to generate a testing result RUT according to the testing command CMD_T.

In this embodiment, the servo module 31 transmits the system parameter REF_S of the to-be-tested terminal 3 to the test operating terminal 21 and receives the operating command CMD_O through a network. After the testing module 32 has generated the testing result RUT, the servo module 31 further transmits the testing result RUT to the test operating terminal 21.

In addition, the remote testing system 2 may further include a test operating terminal 22. The servo module 31 transmits the system parameter REF_S of the to-be-tested terminal 3 or the testing result RUT to the test operating terminal 22. In addition, the test operating terminal 22 may output the operating command of another user to command the to-be-tested terminal to test.

In this embodiment, the servo module 31 synchronously transmits the system parameter REF_S of the to-be-tested terminal 3 or the testing result RUT to the test operating terminals 21 and 22, such that the users respectively at the test operating terminals 21 and 22 can obtain the information of the to-be-tested terminal 3 simultaneously.

In other words, the servo module has to ensure that each test operating terminal can receive the testing result after the to-be-tested terminal executes the test. Thus, each test operating terminal can know the tests performed in other test operating terminal(s). In addition, the servo module has to control the testing procedure. For example, the to-be-tested terminal would not execute the next operating command until the current operating command instructed is completed.

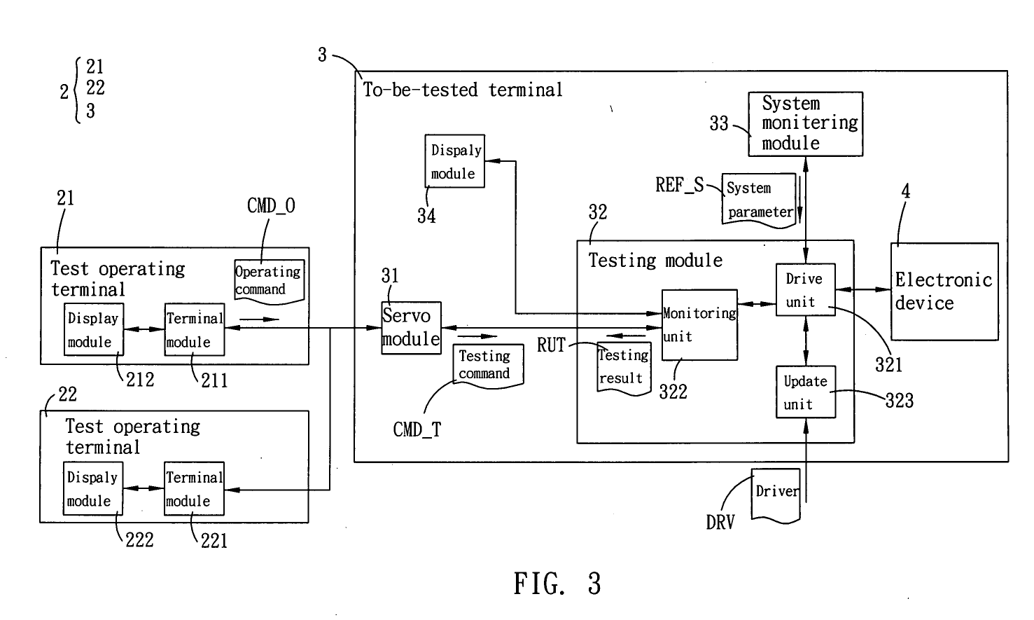

As shown in FIG. 3 that shows the detailed implementation of the remote testing system 2 in this embodiment, the to-be-tested terminal 3 further includes a system monitoring module 33 and a display module 34. The testing module 32 includes a drive unit 321, a monitoring unit 322 and an update unit 323. The test operating terminal 21 includes a terminal module 211 and a display module 212. The test operating terminal 22 includes a terminal module 221 and a display module 222.

The system monitoring module 33 generates the system parameter REF_S according to a state of the to-be-tested terminal 3. The system parameter REF_S is transmitted to the servo module 31 and the display module 34 through the drive unit 321 and the monitoring unit 322. Therefore, the servo module 31 can transmit the system parameter REF_S to the operating terminal 21 and the operating terminal 22, and the display module 34 can display the system parameter REF_S.

The drive unit 321 drives the electronic device 4. The monitoring unit 322 monitors the state of the electronic device 4 through the drive unit 321 to generate the testing result RUT according to a testing command COM_T. The display module 34 receives and displays the testing result RUT coming from the monitoring unit 322.

In addition, the update unit 323 downloads a driver DRV corresponding to the electronic device 4 according to the testing result RUT, and updates the drive unit 321 or the drive unit of the operation system (not shown) in the to-be-tested terminal 3 according to the driver DRV. To be noted, the drive unit 321 of the testing module 32 and the drive unit of the operation system (not shown) in the to-be-tested terminal 3 may refer to the same software, firmware, or hardware. In this embodiment, the update unit 323 may automatically check or download the driver DRV according to the testing result RUT, or the user can manually command the update unit 323 to receive the driver DRV according to the testing result RUT.

The terminal module 211 outputs the operating command CMD_O of the user and receives the system parameter REF_S or the testing result RUT. The display module 212 displays the system parameter REF_S or the testing result RUT.

The terminal module 221 receives the system parameter REF_S or the testing result RUT, and the display module 222 displays the system parameter REF_S or the testing result RUT. In addition, the terminal module 221 can output another operating command of another user to command a test of the to-be-tested terminal.

In addition, the electronic device 4 may be a circuit board, such as a motherboard, and the servo module 31, the drive unit 321, the monitoring unit 322, the update unit 323, the system monitoring module 33 or the display module 34 of the to-be-tested terminal 3 may be implemented on this motherboard to test the motherboard. The test operating terminal may be a personal computer, a mobile communication device or a personal mobile assistant (PDA). Thus, the developer can test the electronic device 4 without being restricted by the distance.

In this embodiment, the servo module 31, the drive unit 321, the monitoring unit 322, the update unit 323, the system monitoring module 33, the display module 34, the terminal module 211, the display module 212, the terminal module 221 or the display module 222 may be implemented by object-oriented program languages such as JAVA, “.NET”, C++, or the like, or other program languages. If the JAVA or “.NET” program languages are used, the remote testing system may be implemented on the personal computer, the mobile communication device or the personal mobile assistant according to the cross-platform properties of the program languages.

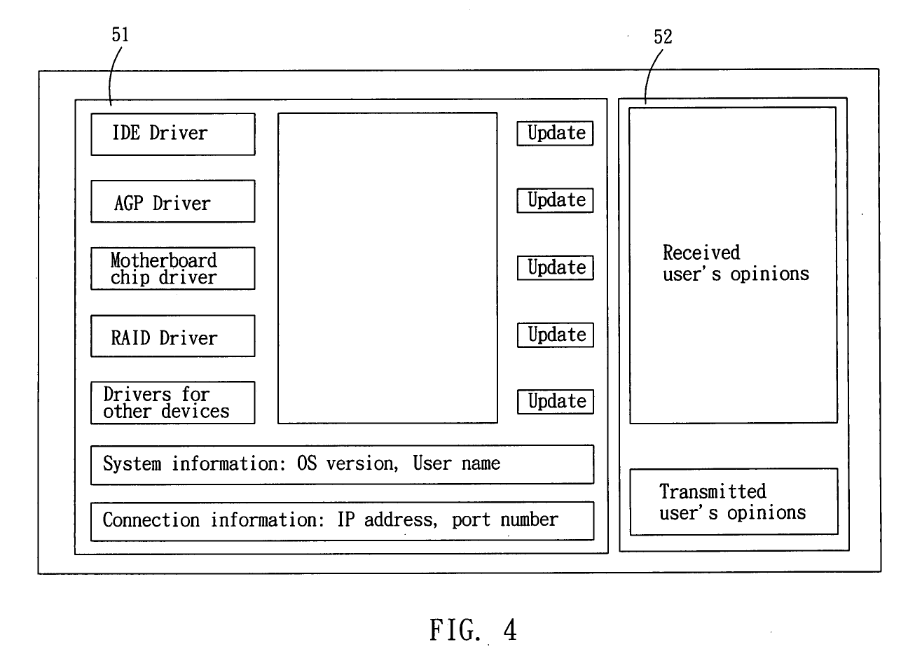

As shown in FIG. 4, the display module can display a system parameter 51 of the to-be-tested system such as the version of driver information, system information, and connection information. Herein, the system parameter may include the version of the driver information of IDE, AGP, motherboard chip, RAID, or other devices, or include the version of the system information, connection information, or the like. In addition, an update key in the right-hand side of each driver information enables the user to command the to-be-tested terminal to update the driver. An interactive window 52 displayed at the right side of the display module enables the users of the to-be-tested terminals or the test operating terminals to interchange their opinions through texts, pictures, voice or images.

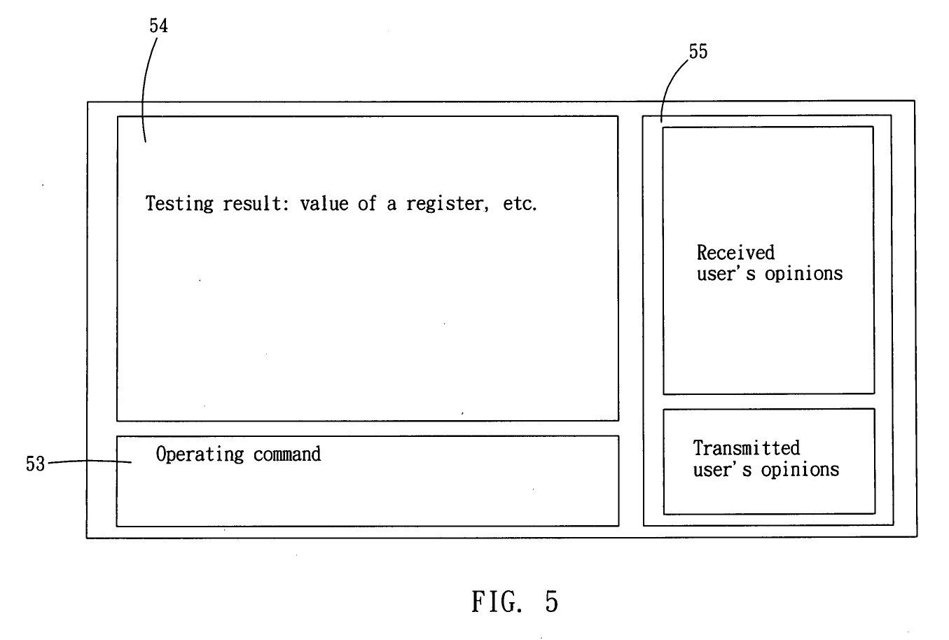

As shown in FIG. 5, the display module can display an operating command 53 and a testing result 54 of a to-be-tested system. The testing result may include a value of a register in a system chip, or a value of a register in a CPU (Central Processing Unit). The display module can display the operating command received by the to-be-tested terminal, and display the testing result generated according to the operating command of each test operating terminal. The interactive window 55 displayed at the right side of the display module enables the users beside the to-be-tested terminals or the test operating terminals to interchange their opinions through texts, pictures, voice or images.

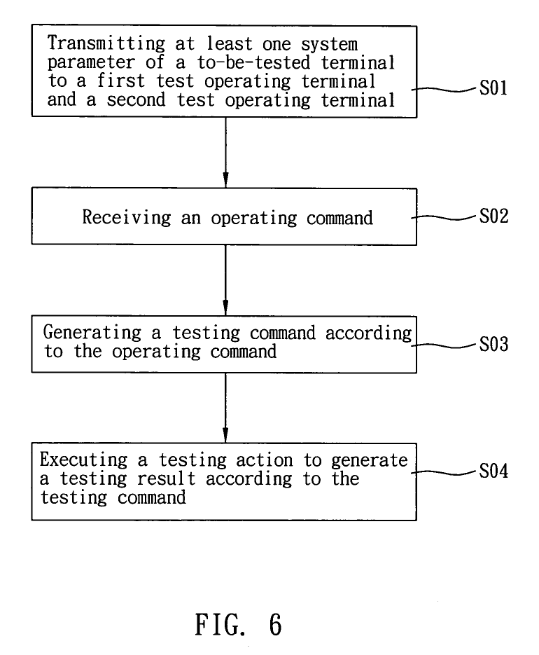

As shown in FIG. 6, the invention also provides a remote testing method including steps S01 to S04.

Step S01 transmits at least one system parameter of a to-be-tested terminal to a first test operating terminal and a second test operating terminal.

Step S02 receives an operating command, which is outputted from one of the first test operating terminal and the second test operating terminal.

Step S03 generates a testing command according to the operating command.

Step S04 executes a testing action to generate a testing result according to the testing command.

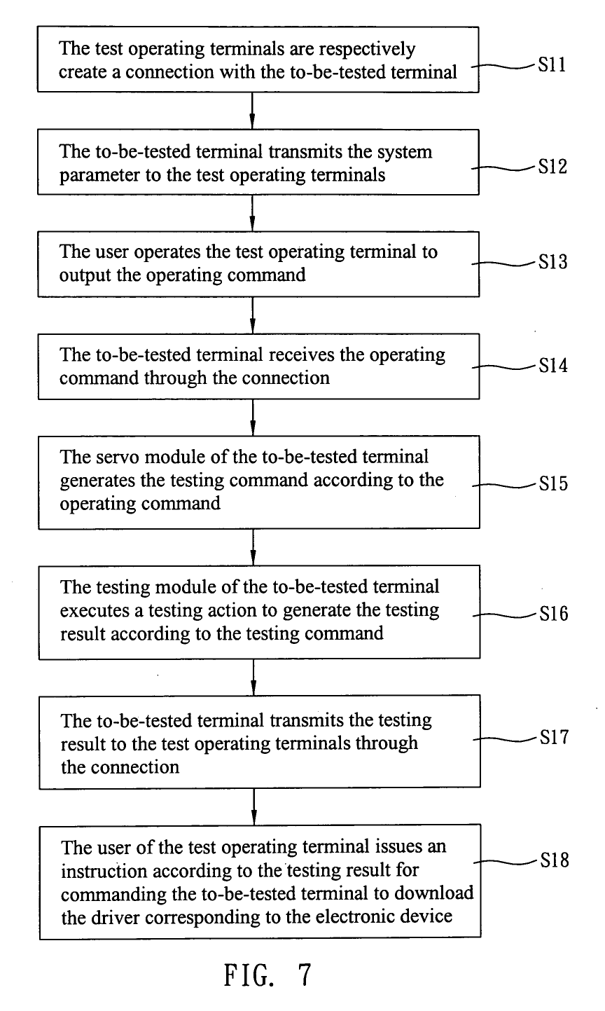

The remote testing method of this embodiment may be applied to the above-mentioned remote testing system, which has been discussed in the embodiment in view of FIGS. 2 to 5, and the detailed descriptions about the remote testing system will not be described hereinafter. With reference to FIG. 7, the detailed steps of the remote testing method will be described as follow.

In step S11, the test operating terminal 21 and the test operating terminal 22 are respectively create a connection with the to-be-tested terminal 3. In this case, the connection is created through, for example, the Internet or the communication network.

In step S12, the to-be-tested terminal 3 transmits the system parameter 51 to the test operating terminal 21 and the test operating terminal 22.

In step S13, the user of the test operating terminal 21 or the test operating terminal 22 operates the test operating terminal 21 or the test operating terminal 22 to output the operating command CMD_O.

In step S14, the to-be-tested terminal 3 receives the operating command CMD_O through the connection.

In step S15, the servo module 31 of the to-be-tested terminal 3 generates the testing command CMD_T according to the operating command CMD_O.

In step S16, the testing module 32 of the to-be-tested terminal 3 executes a testing action to generate the testing result RUT according to the testing command CMD_T. In this case, the procedures of the testing action are discussed in the previous embodiment (as shown in FIGS. 2 to 5), so the detailed descriptions are omitted for concise purpose.

In step S17, the to-be-tested terminal 3 transmits the testing result RUT to the test operating terminals 21 and 22 through the connection.

In step S18, the user of the test operating terminal 21 or the test operating terminal 22 issues an instruction according to the testing result RUT for commanding the to-be-tested terminal 3 to download the driver DRV corresponding to the electronic device 4.

After the above steps, the electronic device 4 of the to-be-tested terminal 3 can finally be normally operated according to the downloaded driver DRV.

In summary, since the remote testing system and method of the invention provide the servo module and the testing module, the remote testing system can transmit the system parameter of the to-be-tested terminal to a remote test operating terminal. Thus, the remote developer can perform the testing action of testing the electronic device without going to the on-site electronic device developing place so as to overcome the distance barrier between the developer and the on-site electronic device developing place and enhance the efficiency of developing the electronic device. In addition, the system parameter of the to-be-tested terminal may be synchronously transmitted to a plurality of remote test operating terminals. Therefore, the remote developers can synchronously test the to-be-tested terminal, and the efficiency of testing the electronic device can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A remote testing system, comprising:
at least one test operating terminal, which outputs an operating command; and
a to-be-tested terminal, which comprises a servo module and a testing module, wherein the servo module transmits at least one system parameter of the to-be-tested terminal to the test operating terminal, receives the operating command, and generates a testing command according to the operating command, and the testing module executes a testing action to generate a testing result according to the testing command.

2. The remote testing system according to claim 1, wherein the servo module transmits the system parameter of the to-be-tested terminal to the test operating terminal and receives the operating command through a network.

3. The remote testing system according to claim 1, wherein the remote testing system comprises at least two test operating terminals, and the servo module synchronously transmits the system parameter of the to-be-tested terminal to the test operating terminals.

4. The remote testing system according to claim 3, wherein the servo module further synchronously transmits the testing result to the test operating terminals.

5. The remote testing system according to claim 1, wherein the servo module further transmits the testing result to the test operating terminal.

6. The remote testing system according to claim 1, wherein the to-be-tested terminal further comprises:
a display module, which displays the testing result.

7. The remote testing system according to claim 1, wherein the test operating terminal comprises:
a display module, which displays the system parameter of the to-be-tested terminal and the testing result.

8. The remote testing system according to claim 1, wherein the to-be-tested terminal has at least one electronic device and the testing module comprises:
a drive unit, which drives the electronic device; and
a monitoring unit, which monitors a state of the electronic device to generate the testing result according to the testing command.

9. The remote testing system according to claim 8, wherein the testing module comprises:
an update unit, which downloads a driver corresponding to the electronic device according to the testing result, and updates the drive unit according to the driver.

10. The remote testing system according to claim 8, wherein the electronic device is a circuit board.

11. A remote testing method, comprising:
transmitting at least one system parameter of a to-be-tested terminal to a first test operating terminal and a second test operating terminal;
receiving an operating command, where the operating command is outputted from one of the first test operating terminal and the second test operating terminal;
generating a testing command according to the operating command; and
executing a testing action to generate a testing result according to the testing command.

12. The method according to claim 11, wherein the step of transmitting the system parameter of the to-be-tested terminal to the first test operating terminal and the second test operating terminal is performed through a network.

13. The method according to claim 11, wherein the step of receiving the operating command is performed through a network.

14. The method according to claim 11, wherein the step of transmitting the system parameter of the to-be-tested terminal to the first test operating terminal and the second test operating terminal comprises:
synchronously transmitting the system parameter of the to-be-tested terminal to the first test operating terminal and the second test operating terminal.

15. The method according to claim 14, further comprising:
synchronously transmitting the testing result to the first test operating terminal and the second test operating terminal.

16. The method according to claim 11, further comprising:
transmitting the testing result to the first test operating terminal and the second test operating terminal.

17. The method according to claim 11, further comprising:
displaying the system parameter of the to-be-tested terminal and the testing result in the first test operating terminal and the second test operating terminal.

18. The method according to claim 11, wherein the step of executing the testing action to generate the testing result according to the testing command comprises:
driving an electronic device of the to-be-tested terminal; and
monitoring a state of the electronic device to generate the testing result according to the testing command.

19. The method according to claim 18, further comprising:
downloading a driver corresponding to the electronic device according to the testing result; and
updating the drive unit according to the driver.

20. The method according to claim 11, further comprising:
generating the system parameter according to a state of the to-be-tested terminal.
